(19) United States
(12) Patent Application Publication
(10) Pub. No.: US 2025/0392864 A1
(43) Pub. Date: Dec. 25, 2025

(54) METHOD OF PERFORMING ROOM CORRECTION FOR AUDIO SYSTEM, COMPUTER PROGRAM PRODUCT, MOBILE DEVICE, AND AUDIO SYSTEM

(71) Applicant: Tymphany HK Limited, Wanchai (HK)

(72) Inventor: Ryan Meng-Wei LU, Taipei City (TW)

(21) Appl. No.: 19/191,244

(22) Filed: Apr. 28, 2025

Related U.S. Application Data
(60) Provisional application No. 63/663,961, filed on Jun. 25, 2024.

(51) Int. Cl. H04R 3/04; H04R 29/00

(52) U.S. Cl. CPC H04R 3/04; H04R 29/001; H04R 2420/07

(57) ABSTRACT

A method of performing room correction for an audio system using a mobile device, including at least one microphone having an unknown microphone frequency response characteristic, includes obtaining a near-field sound recording of a first instance of an audio test sound, obtaining a far-field sound recording of a second instance of the audio test sound, processing the near-field and far-field sound recording and modelling one or more correction filters for application on audio signals of the audio system. The correction filter corrects audio signals to a target frequency response characteristic at the far-field position, e.g. a user's listening position.

### CROSS REFERENCE TO RELATED APPLICATIONS

This application claims priority of U.S. Provisional Application No. 63/663,961 filed on Jun. 25, 2024 under 35 U.S.C. § 119 (e), the entire contents of all of which are hereby incorporated by reference.

### DESCRIPTION

### Background of the Invention

### Field of the Invention

The present invention relates to a method of performing room correction for an audio system, a computer program product for performing room correction, a mobile device for performing room correction, and an audio system configured for performing room correction.

### Description of the Related Art

Room correction in connection with audio systems generally refers to techniques used to compensate for acoustic characteristics of a room in order to improve sound quality and ensure more accurate playback of audio. Acoustic room characteristics are often referred to as room-gain frequency response characteristics. Every room, for example of a living home, has its own unique shape, size, materials, and reflective and absorptive surfaces of walls, objects, such as furniture etc., all of which influence how sound behaves within that room. These factors can cause issues like uneven bass response, reflections, standing waves, and other distortions that affect the clarity and balance of audio.

Sound output components, such as loudspeakers, are normally designed to have a rather flat frequency response. Usually, the frequency response of the sound output components is measured in an anechoic chamber having optimal acoustics, such as minimum reverberation and reflections that interfere with the frequency response.

In real world situations, when loudspeakers are placed in a user's room, the acoustic space is different, i.e. non-anechoic, wherein the walls, floors, furniture etc. will contribute to reflections and can interfere with the frequency response, creating peaks and dips in the frequency response.

Room correction methods have been tackling this problem with digital signal processing and measurement reference microphones. Normally, by measuring audio sound at a listening position with a reference microphone, algorithmic methods may be used to calculate a set of correction filters to remove the peaks and dips and make the listening position frequency response closer to a flat curve.

For such methods to work accurately, it is crucial to have an accurate reading of the listening position frequency response. Therefore, a reference microphone is normally required to perform the listening position frequency response measurement. This is cumbersome and comparatively complex since it requires a separate reference microphone and performing the room correction measurements by the user. The reference microphone is required because such microphones have a known response, so that, even if the reference microphone does not have an ideal flat frequency response, the known response can be used for calibrating the microphone to an accurate measurement.

According to known techniques, providing applications for execution on mobile devices, such as smartphones or tablet computers, and using the microphones of the mobile devices have been suggested for room calibration. However, due to acoustic deficiencies of the mobile device's microphones and significant differences in the acoustic characteristics of the microphones between different types of mobile devices, such known techniques generally do not provide satisfactory results for room correction and adapting the frequency at the desired listening position.

### SUMMARY OF THE INVENTION

In view of the foregoing, it is an object to provide an improved way for performing room correction using mobile devices and their microphones. In particular, it is an object to provide a method of performing room correction for an audio system using a mobile device's microphone(s) having unknown frequency responses, wherein the method provides improved, in particular optimal, room correction and adaption of the far-field frequency response, e.g. the frequency response at a desired listening position. Further objects are related to providing a corresponding computer-program product, a mobile device, and an audio system.

These objects are solved by the present invention.

According to an embodiment of the present invention, a method of performing room correction for an audio system using a mobile device, such as a smartphone, tablet computer, laptop or similar, is provided. The mobile device comprises or includes at least one microphone for recording audio, the microphone having an unknown microphone frequency response (FR) characteristic. A mobile device shall, in particular, be considered as a mobile electronic device including one or more processing units and the microphone, and amongst other components a user interface, such as a display. The microphone and one or more processing units may be operatively coupled and configured to enable recording audio sound using the microphone. The one or more processing units may further be configured for processing recorded audio.

As such, the suggested method is for use with arbitrary mobile devices, where the frequency response characteristic of the microphone or the microphones of the mobile device are not known. In particular, the method suggested herein may be implemented in an application for execution on any mobile device, where improved room correction results may be obtained substantially irrespective of the microphone frequency response characteristic.

The audio system comprises at least one sound output component, such as a loudspeaker. The sound output component is placed in a fixed position in a room, such as a room in a living home or any other room. The sound output component has an output frequency response characteristic, and the room has an unknown room-gain frequency response characteristic.

In this connection, the frequency response characteristic of audio sound output by the output component at a listening position is influenced or distorted by the room-gain frequency response characteristic. In particular, the frequency response (FFP_FR) at a listening position (far-filed position, FFP) may be considered as the sum of the output component frequency response (OC_FR) and the room-gain frequency response (RG_FR): FF_FR=OC_FR+RG_FR. In order to optimize the audio quality at the listening position, it is desirable to remove at least the room-gain frequency response, to obtain, for example, a comparatively flat frequency response curve, or to obtain a desired, e.g. user selectable, frequency response curve, which may not be flat and provide desired “room effect”.

According to the underlying invention and the present disclosure, optimizing the frequency response at a listening position is, inter alia, obtained based on frequency response curves, wherein one or more frequency response curves are obtained based on recorded audio test sounds outputted by the output component and recorded by the mobile device's microphone(s).

One exemplary embodiment of a corresponding method will be described below.

The method may comprise obtaining a near-field (NF) sound recording generated by recording, with the microphone positioned at a near-field position (NFP) relative to the output component within the room, a first instance of an audio test sound outputted by the sound output component into the room.

The audio test sound may for example be recorded by a user placing the mobile device at the near-field position for recording the audio test sound. In certain exemplary embodiments of the present invention, the user may be instructed to place the mobile device at the near-field position, e.g. close to the output component, and, if placed accordingly, to start recording the audio test sound. According to certain exemplary embodiments of the present invention, user instructions for placing the mobile device may be displayed on a user interface of the mobile device, provided, for example, as a user interface of an application executed on the mobile device for carrying out the room correction. Recording the audio test sound may involve one or more user interactions with selectable items displayed on the user interface, e.g. confirmations such as “Mobile Device placed at Near-Field Position”, and controls such as “Start placing/recording Audio Test Sound”. In certain exemplary embodiments, the user interface may include or provide selectable items for generating instructions to be sent, in particular over a wireless communication, between the mobile device and the audio system instructing the audio system to output the audio test sound.

The method further comprises obtaining a far-field (FF) sound recording generated by recording, with the microphone positioned at a far-field position (FFP) relative to the output component, a second instance of the audio test sound outputted by the sound output component into the room. The far-field position may correspond to a desired listening position of, for example, a user within the room.

Recording the second instance of the audio test sound may involve similar operations and/or interactions at or with the mobile device described in connection with the recording of the audio test sound at the near-field position. For example, after recording the first instance of the audio test sound, which may for example include a corresponding user confirmation, a user instruction may be displayed on the display of the mobile device to place or position the mobile device at the far-field position. The mobile device may then receive, via the user interface, a confirmation that the mobile device is positioned at the far-field position, and may receive or generate an instruction to proceed with recording the audio test sound. In this connection, the mobile device may instruct, via a wireless communication, the audio system to output the audio test sound, and the mobile device, e.g. after a corresponding instruction received at the user interface, may then record the audio test sound. All steps for performing the room correction may be carried out automatically where appropriate.

The audio test sound may, for example, be a defined test tone or sound, including for example a sine sweep.

The near-field position is close to the sound output component, e.g. in a range up to 10 cm. In particular, the near-field position may be selected such that room-gain effects are negligible or insignificant. The far-field position is different from the near field position and spaced further away from the sound output component as compared to the near field position, e.g. in a range up to several metres from the output component. As mentioned, the far-field position may correspond to a desired listening position, e.g. a position on a couch or other seating or lying accommodation in the room. At the far-field position, audio is affected by room-gain effects.

The method further comprises processing, preferably by one or more processing units of the mobile device, by the audio system, or by one or more remote processing units of a remote (computing) device, the near-field and far-field sound recording and extracting from the near-field sound recording a near-field frequency response curve and from the far-field sound recording a far-field frequency response curve. The frequency response curve may for example correspond to a digital representation of a decibel over frequency graph.

The method further comprises extracting from the far-field frequency response curve a room-frequency response curve corresponding to the room-gain frequency response characteristic by eliminating, in the far-field frequency response curve, based at least on the near-field frequency response curve, both the output frequency response characteristic and the microphone frequency response characteristic. In particular, this step may involve eliminating, from the far-field frequency response curve, the frequency response components resulting from the frequency response characteristic of the microphone and from the frequency response characteristic of the room. In other words, the resulting frequency response curve mirrors or substantially mirrors the “true” room-gain frequency response characteristic, i.e. the frequency response characteristic of the room.

The method further comprises modelling, based on the room-gain frequency response curve and a given target frequency response curve, a correction filter for application on audio signals of the output component, the correction filter cancelling out at least the room-gain frequency characteristic and correcting the audio signals to obtain, at the far-field position, the target frequency response characteristic corresponding to the target frequency response curve.

Modelling the correction filter may comprise modelling one or more, or a set of correction filters, which, when applied to audio signals, “correct” or modify the audio signals such that corresponding audio sound perceived at the far-field position corresponds to the target frequency response curve.

With regard to modelling corrections filters from a corresponding frequency response curve, reference is made for example to U.S. Patent Application Publication No. 2024/0323626 A1, which is fully incorporated herein by reference. In connection with respective filters, the present disclosure explicitly and specifically refers to and incorporates by reference paragraphs [0039] to [0052], paragraphs to and FIGS. 3a to 3d of U.S. Patent Application Publication No. 2024/0323626 A1, wherein such filters may be applied for the purpose of the invention described herein.

The method steps as described need not be performed in the order as described above. In particular, the order of the method steps may, as appropriate, be different and method steps may, at least partially, overlap.

The target frequency response curve may be a fixed frequency response curve, or the target frequency response curve may be one of one or more target frequency response curves selectable by user. In various embodiments, an application for execution on the mobile device may be configured to provide operational modes enabling a user to select and set a target response curve from one or more predefined target response curves stored in the application. In various embodiments, the application may further be configured to enable users to define their own target response curves for use with the method.

According to the present disclosure and the findings of the underlying invention, the suggested method utilizing the various frequency response curves as mentioned provides an efficient way for eliminating the room-gain frequency characteristic. For example, by applying the correction filters, the audio system may be operated such that audio sound perceived at the far-field position corresponds to or substantially corresponds to audio sound as if perceived at the near-field position, e.g. conforming to the “true” frequency response characteristic of the output component. Further, by applying the suggested method, the audio system may be operated such that audio sound perceived at the far-field position corresponds to a target or desired “room effect” when listening to audio. Here, the target frequency response curve may be different from the “true” near-field frequency response curve of the sound output component. For example, it may be desirable to boost certain frequencies in perceived audio, e.g. at the lower frequencies to give a warmer listening experience. Such correction to a target frequency response may be considered as providing an automated equalizer function.

Further, the suggested method provides a comparatively easy way of enabling even non-expert users to perform room correction. For example, and as already mentioned, the method may be implemented in an application for execution on a mobile device, such as a smartphone etc., wherein the application may guide the user through the room correction process, and wherein the application may, e.g. via a wireless communication established between the mobile device and the audio system, automatically or at least semi-automatically (e.g., with minimal user interaction) configure the audio system to the target frequency response curve.

Yet further, the present disclosure and the underlying invention are based on the finding that the various response curves disclosed in connection with the suggested method enable efficient and high-quality room correction using built-in microphones of known mobile devices (smartphones etc.). In this connection, it is important to note that the quality and microphone frequency response curves of microphones of usual mobile devices may vary greatly and are generally unknown. The suggested method, however, may perform appropriate room correction substantially irrespective of the quality and microphone frequency response curves of the microphones of the mobile device used. In particular, the method may be carried out even with initially unknown frequency response characteristics.

Hence, the suggested method provides an improved and efficient way for room correction and is comparatively user-friendly and easy-to-use.

In various embodiments, the method may further comprise the steps of (actively) recording the near-field sound recording and the far-field sound recording with the mobile device including the at least one microphone. This means that the method as a whole may, for example, be carried out on the mobile device, requiring for example minimal user interaction, and the recorded sound recordings may be automatically processed by one or more processing units of the mobile device for modelling the correction filter. In other embodiments, a remote computing device may obtain the sound recordings, for example via a wireless communication, and automatically process the sound recordings for modelling the correction filter.

In various embodiments, and as indicated above, in the near-field position, a distance between the microphone and the sound output component may be 10 cm at most. In particular, the near-field position may be selected such that room-gain effects in recorded audio, specifically in audio test sound, is negligible or insignificant. Therefore, the frequency characteristic of recorded audio test sound at the near-field position is represented as an overlay of the output frequency response characteristic of the sound output component and the microphone frequency characteristic of the microphone, but is (except for, for example, negligible contributions) void of room-gain characteristics.

In various embodiments, and as discussed further above, the mobile device is selected from the group comprising: a smartphone, a tablet computer, a laptop, headphones comprising one or more microphones, remote controls comprising a microphone or at least a microphone input.

According to various embodiments, the method may further comprise establishing a wireless communication link between the mobile device and the audio system, instructing, by the mobile device placed in the near-field position, via first instructions transmitted over the wireless communication link, the audio system to output the first instance of the audio test sound, and instructing, by the mobile device placed in the far-field position, via second instructions transmitted over the wireless communication link, the audio system to output the second instance of the audio test sound. This may contribute to automating the room correction process and provide an overall user-friendly process.

In various embodiments, the method may further comprise transmitting the correction filter via a wireless communication link established between the mobile device and the audio system to the audio system and, by the audio system, applying the correction filter to audio output. Again, this may contribute to automating the room correction process and provide an overall user-friendly room correction application and processing.

In various embodiments, the eliminating of the microphone frequency response characteristic and the output frequency response characteristic may comprise determining a microphone frequency response curve based on a calculated difference of the near-field frequency response curve and a known frequency response curve of the output component; modelling a microphone correction filter based on the microphone frequency response curve, the microphone correction filter cancelling out the microphone frequency response characteristic; applying the microphone correction filter to the far-field sound recording; and eliminating the output frequency response characteristic from the far-field frequency response curve by subtracting the known output frequency response curve.

In such embodiments, the unknown microphone response characteristic may be determined, for example, by subtracting from the near-field frequency response curve the known output frequency response curve. The output frequency response curve may be provided together with the output component, e.g., stored thereon or in the audio system, and may be determined using a reference microphone in an anechoic chamber. The output component frequency response curve may for example be determined in connection with the manufacture, at the manufacturer, or the distributor of the output component or otherwise. Using the known output frequency response curve, which, based on the reference microphone, may be determined comparatively accurately (e.g., a comparatively flat curve over a given range of output frequencies of the output component), the room correction may further be improved.

In connection with such embodiments and as an illustrative example, if OC_FR represents the known output component frequency response, NFP_FR represents the near-field frequency response, FFP_FR represents the far-field frequency response, RG_FR represents the room-gain frequency response, M_FR represents the microphone frequency response, and T_FR represents a desired target frequency response, room correction can be exemplified as follows:

The room-gain frequency response may be obtained as NFP_FR−FFP_FR=−RG_FR.

A correction frequency response curve C_FR may be defined as C_FR=−RG_FR+RG_FR (desired), in which RG_FR (desired) is given by: RG_FR (desired)=T_FR-OC_FR.

The known OC_FR may be used for determining the M_FR based on the NFP_FR as M_FR=NFP_FR-OC_FR, wherein this M_FR can then be used for eliminating the M_FR in the FFP_FR, because the M_FR will be substantially the same at the NFP and FFP. Below, FFP_FR* represents the calibrated FFP_FR after eliminating the microphone response M_FR. FFP_FR* can then be expressed as: FFP*_FR=OC_FR+RG_FR.

Taking the above equations and relationships together, and “superposing” the FFP*_FR with the C_FR, the following applies for the “corrected” frequency response curve at the far-field position FFP_FR (corr):

FFP_FR(corr)=FFP*_FR+C_FR=

=(OC_FR+RG_FR)+(−RG_FR+RG_FR(desired))

=OC_FR+RG_FR(desired)

=OC_FR+T_FR−OC_FR

=T_FR

That is, based on the recorded NFP_FR, the FFP_FR, and the known OC_FR, a target frequency response curve may be determined, which may then be used for modelling the correction filter or set of correction filters. Applying the correction filter(s) to the audio output, the audio at the far-field position corresponds to the T_FR, i.e., the audio output at the FFP can be perceived according to the target frequency response curve.

In various embodiments, the elimination of the microphone frequency characteristic and the output frequency response characteristic comprises eliminating the microphone frequency characteristic and the output frequency response characteristic based on a calculated difference between the far-filed frequency response curve and the near-field frequency response curve. In this case, the correction filter may be determined without knowing the output frequency response characteristic. In particular, in such embodiments, but not limited thereto, a normalizing mechanism, algorithm, or function may be applied that takes both near-field and far-field frequency curves and that normalizes the near-field and far-field frequency curves to a similar level. The normalizing mechanism, algorithm, or function may be applied after extracting the near-field and far-field frequency curves and before calculating the difference, in particular before extracting the room-gain frequency response characteristic and before the modelling of the correction filters.

A specific frequency range may be selected for the normalizing mechanism, algorithm, or function. For example, and according to an exemplary embodiment, in which a phone microphone having, for example, a (substantially) linear characteristic and low distortion in the range from 40 Hz to 500 Hz is used for performing the room correction, a frequency range from 300 Hz to 500 Hz may be selected. Room modes are often or usually located in the region below 300 Hz. Therefore, the range from 300 Hz to 500 Hz qualifies for normalization, in particular, for aligning the curves. By this, a room correction may be obtained that is suitable for correcting the far-field response from 40 Hz to 300 Hz (where room modes are located) and for maintaining similar levels in the remaining frequency range (>500 hz).

In connection with such embodiments and as an illustrative example, if OC_FR represents the unknown output component frequency response, NFP_FR represents the near-field frequency response, FFP_FR represents the far-field frequency response, RG_FR represents the room-gain frequency response, M_FR represents the microphone frequency response, and T_FR represents a desired target frequency response, room correction can be exemplified as follows.

Assuming that the room gain at the near-field position is negligible, the near-field position frequency response NFP_FR may be considered as a superposition of the output frequency response and the microphone frequency response: NFP_FR=OC_FR+M_FR.

The far-field frequency response FFP_FR includes, in addition to the OC_FR and the M_FR the RG_FR: FFP_FR=OC_FR+M_FR+RG_FR.

A correction curve C_FR may be obtained based on difference curve between NFP_FR and FFP_FR: C_FR=NFP_FR-FFP_FR=−RG_FR.

The correction curve, mirroring the inverse of the room-gain frequency response, may then be used for modelling one or more correction filters. Applying the correction filters to audio output, the room-gain can be cancelled out at the far-field position.

For cancelling out the room-gain at the far-field position, the microphone frequency response characteristic does not need to be known. Hence, the room correction may be carried out using, for example, any type of mobile device without knowledge of the microphones installed with the mobile device, which also applies to the above embodiments. In this connection, the correction filter is (at least not substantially) distorted by the unknown microphone frequency response. This is of particular advantage in connection with providing room correction applications for mobile devices, as such applications are generally designed to be installed on a plurality of different mobile devices, where it is impossible to consider each and every model and possible in-use modifications (e.g., protective covers, shells etc., possibly modifying the microphone response characteristic).

In the above equations of the given illustrative examples, the (known) frequency response of the audio test sound has been omitted or neglected, because the frequency response of the audio test sound is, as a “test sound”, assumed to be “flat”, i.e., it is assumed to provide no peaks or dips in the frequency response. However, the (known) frequency response of the audio test sound may also be considered, in general and in particular in connection with the above illustrative examples.

In various embodiments, the target frequency response curve corresponds to a frequency response curve of the output component. This means, the correction filter may be modelled to eliminate the room-gain frequency response such that the audio at the far-field position corresponds with the output frequency response characteristic.

In various embodiments, the target frequency response curve may correspond to a substantially flat frequency response curve. The term “flat” in particular shall mean that the frequency response curve (e.g., decibel over frequency curve) corresponds to a substantially constant function, or to a linear function, over the frequency range covered by the audio test sound, or substantially over the frequency range covered by the audio system or sound output component.

In various embodiments, the target frequency response curve corresponds to a virtual, desired, or modelled room-gain frequency response curve providing, when applying the correction filter to audio signals, a desired room gain characteristic at the far-field position. For example, a target frequency response curve may be provided that is not entirely flat, but boosted to some desired extent in a selected frequency range, e.g., in the lower frequency range. This may be used for example for providing a warmer listening experience to the user. Such target frequency response curves may provide an option for manipulating listening preferences of the user (e.g., in connection with Rock, Classic etc.). The term “virtual” in connection with the room-gain frequency response in particular shall relate to a room-gain frequency response different from that of the actual room and mirroring an acoustic experience of a room or area not actually present. Using a virtual room gain frequency response may provide, at the far-field position, i.e., a listening position, an acoustic experience as if the listener was listening to the audio in the virtual room, for example associated with artificial reverberation, reflections etc. that cannot be provided by the room in which the audio system and user is placed.

In various embodiments, a computer-program product, such as but not limited to an application for execution on a mobile device, is provided. The computer-program product comprises or stores instructions on a non-volatile memory, that, when executed by one or more processing units of a computing device, in particular a mobile device, comprising at least one microphone, causes the one or more processing units to carry out a method in accordance with any of the embodiments disclosed herein. In this connection, full reference is made to the detailed discussion above and further below.

In various embodiments, a mobile device, or more generally a (mobile) room correction device, comprising at least one microphone for recording audio sound, at least one processing unit, and a non-volatile memory is provided, the memory storing instructions, that, when executed by the at least one processing unit, cause the one or more processing units to carry out a method in accordance with any of the embodiments disclosed herein. In this connection, full reference is made to the detailed discussion above and further below.

In various embodiments, the mobile device may further comprise a wireless communication unit operatively coupled to the at least one processing unit, and the memory of the mobile device may include further instructions that, when executed by the at least one processing unit, cause the mobile device to carry out at least one of the following actions:
establish a wireless communication with the audio system;
receive a confirmation that the mobile device is positioned at the near-field position;
issue a notification, e.g. via a display unit or a loudspeaker unit of the mobile device, the notification prompting a user to place the mobile device at the near-field position;
receive a confirmation that the mobile device is positioned at the near-field position;
instruct the audio system to output the first instance of the audio test sound;
issue a notification, e.g. via a display unit or a loudspeaker unit of the mobile device, the notification prompting a user to place the mobile device at the far-field position;
receive a confirmation that the mobile device is positioned at the far-field position;
instruct the audio system to output the second instance of the audio test sound; and
transmit the one or more correction filters, after having modelled the one or more correction filters, to the audio system for application to output audio.

Such actions may leverage automated or at least semi-automated room correction.

In various embodiments, an audio system comprising at least one sound output component placed in a room and at least one first control unit, a mobile device comprising a microphone and at least one second control unit, is provided. The first control unit is operatively coupled to a first wireless communication unit of the audio system, and the second control unit is operatively coupled to a wireless communication unit of the mobile device, wherein the first control unit comprises a first processing unit and a first non-volatile memory, and the second control unit comprises a second processing unit and second non-volatile memory, the first and second non-volatile memories storing instructions, which, when executed by the first and second processing unit, respectively and where appropriate, cause the audio system to carry out a method in accordance with any of the embodiments disclosed herein. In this connection, full reference is made to the detailed discussion above and further below.

In various embodiments, the first and second non-volatile memories may comprise further instructions that, when executed by at least one of the first and second processing units, respectively and where appropriate, cause the audio system to carry out at least one of the following actions:
establish a wireless communication link between the mobile device and the audio system;
receive, from the mobile device or at the mobile device, a confirmation that the mobile device is positioned at the near-field position;
receive, at the audio system from the mobile device, an instruction to output the first instance of the audio test sound;
receive, from the mobile device or at the mobile device, a confirmation that the mobile device is positioned at the far-field position;
receive, at the audio system from the mobile device, an instruction to output the second instance of the audio test sound;
transmit from the mobile device and receive at the audio system the one or more correction filters for application, by the audio system, to output audio;
receive, from the mobile device at the audio system, the near-field sound recording and the far-field sound recording and modelling, by the audio system, the one or more correction filters; and
apply, by the audio system, the one or more correction filters to audio output.

Similarly, as above, such actions may be provided for leveraging automation of the room correction.

Regarding the action related to receiving, from the mobile device at the audio system, the near-field sound recording and the far-field sound recording and modelling, by the audio system, the one or more correction filters, this action is related to an embodiment in which the audio system, more precisely the first control unit of the audio system, may perform the correction filter modelling. Furthermore, the correction filter modelling may be carried out by the mobile device, or a different remote device instead; preferably, however, by the mobile device. The entity for modelling the correction filters may be selected depending on the processing power of the mobile device and the audio system. In case of using a remote entity for modelling the correction filters, for example a computing device connectable to the mobile device and/or the audio system over a network, the data required for determining and modelling the correction filters may be transmitted to the remote device, and the modelled correction filters may be received at the audio system from the remote device or from the mobile device acting as an intermediary.

### BRIEF DESCRIPTION OF THE DRAWINGS

Non-limiting examples will now be described in connection with the accompanying drawings. Same or functionally corresponding elements are referenced with same reference signs. In the drawings:

FIG. 1 shows an exemplary scenario for performing room correction in a room;

FIG. 2 shows a flowchart of a method for performing room correction;

FIG. 3 shows a flowchart according to a modification of the method described in connection with FIG. 2;

FIG. 4 shows a flowchart according to a further modification;

FIG. 5 schematically shows a system configuration of a mobile device;

FIG. 6 shows a flowchart of mobile device actions that may be carried out in connection with various embodiments;

FIG. 7 schematically shows a system configuration of an audio system;

FIG. 8 shows a flowchart of audio system actions carried out in connection with various embodiments; and

FIG. 9 shows a further flowchart of a method according to various embodiments.

### DETAILED DESCRIPTION

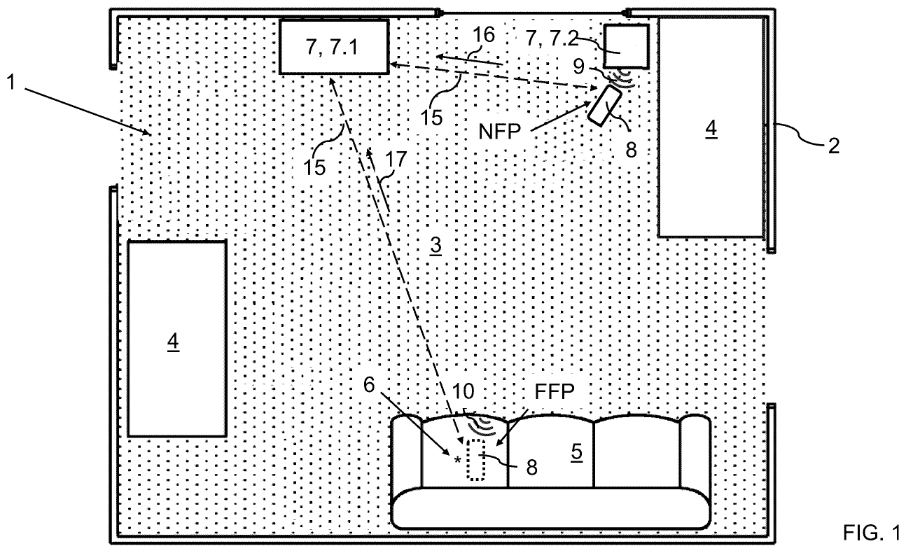

FIG. 1 shows an exemplary scenario for performing room correction in a room 1, which is provided for illustrative purposes. The method according to this disclosure is, however, not limited to the particular room shown, but may be applied to any other room, listening area or scenario.

The room 1 as shown in a top view is defined, as usual, by walls 2 including one or more openings (for a door and one or more windows), a floor 3 and a ceiling (not shown). In the room 1, there are various kinds of objects, such as furniture 4, e.g., cupboards, shelves, etc. In the example of FIG. 1, a couch 5 is placed within the room 1. The couch 5 provides a seating or lying accommodation for the occupant of the room 1. For the purpose of illustration, in the given example reference numeral 6 designates a preferred seating position (additionally highlighted by an asterisk) of the occupant on the couch 5, which corresponds to a desired listening position of the occupant.

In the room 1, there is also an audio system 7 comprising a main component 7.1 for generating, inter alia, audio signals for at least one sound output component 7.2 for outputting audible sound based on the audio signals, e.g. a loudspeaker. While FIG. 1 shows only one sound output component 7.2, the present disclosure is not limited to just one sound output component but is applicable to any number of sound output components. Further, FIG. 1 shows the main component 7.1 and the sound output component 7.2 as two separate entities. This disclosure, however, also covers audio systems in which the two components are integrated into one single component, e.g., a loudspeaker or sound output component, for example a soundbar.

In the scenario shown in FIG. 1, the walls 2, the floor 3, the couch 5, the audio system 7, and other possible items placed in the room will cause reflections and interference with regard to sound output by the sound output component. These components will affect the frequency response of the sound and create peaks and dips in the frequency response, for example at a listening position, which is, for illustrative purposes, assumed to correspond to the preferred seating position 6. The peaks and dips distort, at the listening position 6, the frequency response of the output component, which is usually designed to provide a flat frequency response at least over a large part of the output component's frequency range. The effects caused by the room and the items placed therein on the frequency response is also known as, and referred to herein, as room-gain frequency response or simply room-gain.

In general, the room-gain distorts the listening experience at the listening position 6 and it is, therefore, at least desirable to eliminate unwanted room-gain disturbances and, preferably, to provide a target or desired listening experience. For this purpose, room correction methods according to various embodiments according to this disclosure have been developed tackling this problem with digital signal processing.

In accordance with the present disclosure, a method of performing room correction is provided, which is, inter alia, configured for removing unwanted room-gain effects or disturbances, and is preferably configured to provide a target frequency response at the listening position 6.

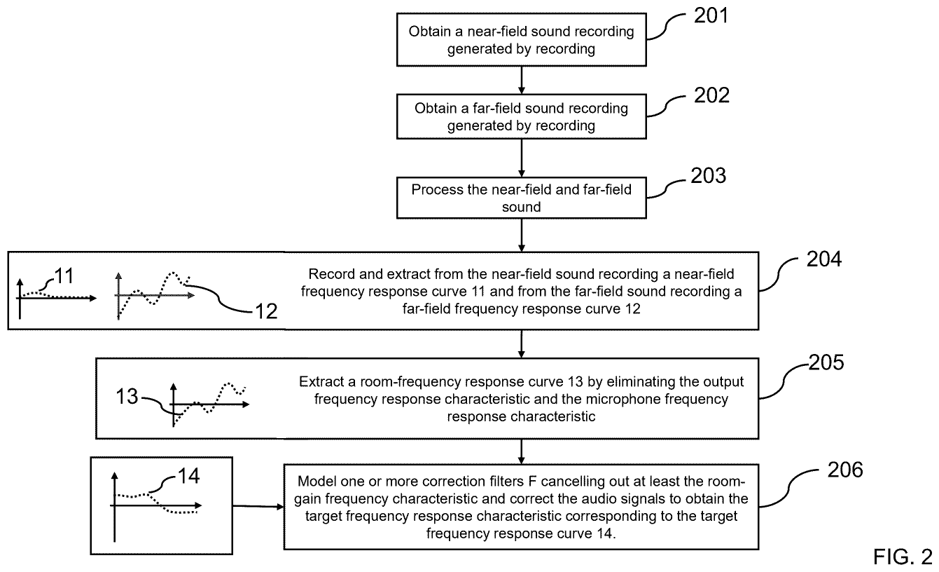

FIG. 2 shows an exemplary flowchart of a method for room correction. The method according to FIG. 2 refers to a near-field position, a far-field position, and a mobile device (e.g., a smartphone) comprising one or more microphones (for simplicity referred to as the microphone in the following). The near-field position is close to the output component 7.2 and indicated by NFP in FIG. 1. The far-field position corresponds to the listening or preferred seating position 6 and is indicated by FFP in FIG. 1. The mobile device is indicated by reference sign 8, shown in solid line in the NFP and in dotted line in the FFP in FIG. 1.

The method is for performing room correction for the audio system 7 using the mobile device 8, e.g., a smartphone, including at least one microphone (not explicitly shown in the figures, but included in the mobile device) having an unknown microphone frequency response characteristic. As shown in FIG. 1, the output component 7.2 is placed in a fixed position in the room 1 and has an output frequency response characteristic. The room has an unknown room-gain frequency response characteristic. The method comprises the following steps, wherein the order of the steps may be varied and may at least partially overlap in time and according to various embodiments and as appropriate, meaning that the method is not limited to the given order of actions (e.g., the NFP recording may be carried out after the FFP recording, etc.):
obtaining 201 a near-field sound recording generated by recording, with the microphone of the mobile device 8 positioned at the near-field position NFP relative to the sound output component 7.2 within the room 1, a first instance 9 of an audio test sound outputted by the sound output component 7.2 into the room; and
obtaining 202 a far-field sound recording generated by recording, with the microphone of the mobile device 8, in particular and preferably the same microphone as for the near-field sound recording, positioned at a far-field position FFP relative to the sound output component 7.2, a second instance 10 of the audio test sound outputted by the sound output component 7.2 into the room 1.

As discussed further above, NFP is close to the sound output component 7.2 and the FFP in the given example corresponds to the desired listening position 6.

The method further comprises processing 203 the near-field and far-field sound recording and extracting 204 from the near-field sound recording a near-field frequency response curve 11 and from the far-field sound recording a far-field frequency response curve 12; and extracting 205 from the far-field frequency response curve 12 a room-frequency response curve 13 corresponding to the room-gain frequency response characteristic by eliminating, based at least on the near-field frequency response curve 11, the output frequency response characteristic and, according to various embodiments, the microphone frequency response characteristic (e.g., by modelling a microphone correction filter based on the near-field frequency response curve and a known output component response curve).

The NFP, FFP, and the room-gain (RG) frequency response (FR) curves are shown only schematically in FIG. 2, wherein the response curves may correspond to digital representations of decibel over frequency graphs. In some embodiments, the RG_FR response curve may be determined without knowing the microphone frequency response curve and without knowing the output component frequency response curve. In embodiments, the output component frequency response curve may be known and may be provided for executing the method, in particular for modelling a microphone correction filter based on the near-field frequency response curve and a known output component response curve. Such a correction filter may be applied for recording the far-field frequency response.

The method further comprises modelling 206, based on the room-gain frequency response curve 13 and a given target frequency response curve 14, one or more correction filters F for application on audio signals of the sound output component 7.2, the correction filter F (which may comprise one or more correction filters or a set of correction filters) cancelling out at least the room-gain frequency characteristic and correcting the audio signals to obtain, at the FFP, the target frequency response characteristic corresponding to the target frequency response curve 14.

The target frequency response curve 14 may be provided as an input to the method, wherein the target frequency response curve 14 may be selected by the user prior to modelling the correction filter F. The target frequency response curve 14 may be stored in a target curve repository accessible for a room correction application installed on the mobile device 8 for performing room correction.

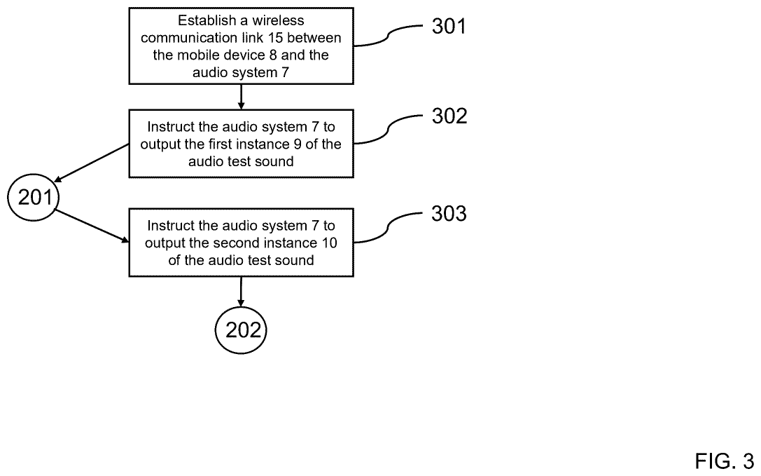

FIG. 3 shows a flowchart according to a modification of the method described in connection with FIG. 2.

As shown in FIG. 3, the method may comprise establishing 301 a wireless communication link 15 between the mobile device 8 and the audio system 7, schematically illustrated in FIG. 1 by a dashed double arrow.

Further, the modification may comprise instructing 302, by the mobile device 8 placed in the near-field position NFP, via first instructions 16 (schematically illustrated in FIG. 1 by an arrow) transmitted over the wireless communication link 15, the audio system 7 to output the first instance 9 of the audio test sound. The mobile device 8 may then record the NFP sound recording, i.e., may obtain the near-field sound recording according to 201 in FIG. 2.

The method according to the modification may further comprise instructing 303, by the mobile device 8 placed in the far-field position FFP, via second instructions 17 transmitted over the wireless communication link 15 (as schematically indicated in FIG. 1), the audio system 7 to output the second instance 10 of the audio test sound. The mobile device 8 may then record the FFP sound recording, i.e., may obtain the far-field sound recording according to 202 in FIG. 2. Then, the method may proceed according to 203 to 206 of the flow diagram of FIG. 2.

In embodiments in which the wireless communication link 15 between the mobile device 8 is established, the mobile device 8 may send the correction filter F over the wireless communication link 15 to the audio system 7 for correcting audio output, the audio system 7 then optionally applying the filter F as desired by the listener.

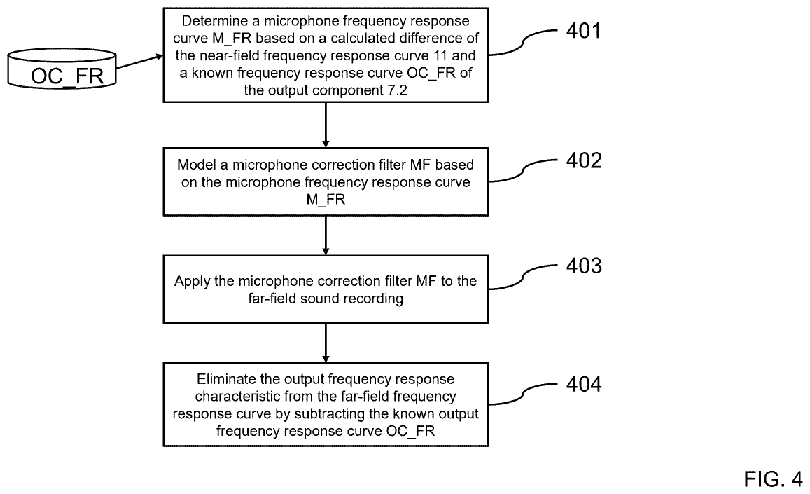

In connection with a further modification of the method and with reference to FIG. 4 showing a flowchart of corresponding modifications, the eliminating of the microphone frequency response characteristic and the output frequency response characteristic may comprise determining 401 a microphone frequency response curve M_FR based on a calculated difference of the near-field frequency response curve 11 and a known frequency response curve OC_FR of the output component 7.2. The output component frequency response curve may be provided by the audio system 7, and may, for example, be transmitted to or requested by the mobile device 8 from the audio system 7 or otherwise (e.g., over the internet). The output frequency response curve may be determined as discussed further above.

The method according to the further modification may further comprise modelling 402 a microphone correction filter MF based on the microphone frequency response curve M_FR, the microphone correction filter MF modelled to cancel out the microphone frequency response characteristic.

The method according to the further modification may further comprise applying 403 the microphone correction filter MF to the far-field sound recording. This means, that the far-field sound recording may be obtained substantially void of the microphone frequency response characteristic. The method may then proceed with eliminating 404 the output frequency response characteristic from the far-field frequency response curve by subtracting the known output frequency response curve OC_FR. By this, the room-gain frequency response curve may be obtained, and the method may proceed according to 206 of FIG. 2 and described above.

According to a variant, the elimination of the microphone frequency characteristic and the output frequency response characteristic may comprise eliminating the microphone frequency characteristic and the output frequency response characteristic based on a calculated difference between the far-filed frequency response curve 12 and the near-field frequency response curve 11.

The target frequency response curve 14 as schematically indicated for illustrative purposes in FIG. 2 may have a particular form. In particular, the target frequency response curve 14 may correspond to a virtual room-gain frequency response curve providing, when applying the correction filter to audio signals, a desired room gain characteristic at the far-field position. This may be used to model a “virtual” room and to provide a frequency response characteristic at the FFP corresponding to the “virtual” room (e.g., a concert hall, a cathedral, an opera etc.). Any type of “virtual” room, i.e., any type of target frequency response curve, may be contemplated.

However, the target frequency response curve 14 may, in embodiments, correspond to a flat curve, providing a substantially constant frequency response over a desired or over the available frequency range. This may be used to model an “ideal” sound output component providing a flat frequency response characteristic at the FFP.

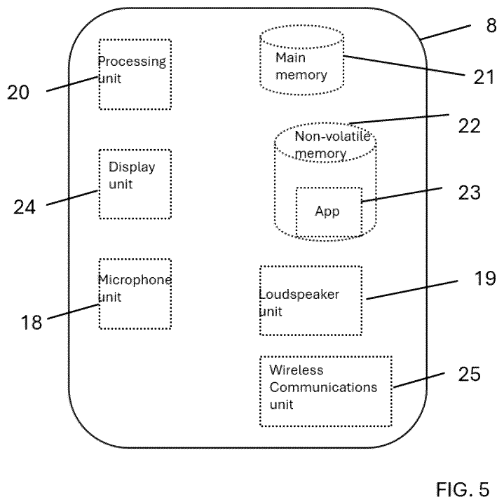

FIG. 5 schematically shows a system configuration of a mobile device 8, for example a smartphone, tablet computer or laptop. The exemplary mobile device 8, e.g. a smartphone, may comprise, amongst other components, a microphone unit 18, which may comprise one or more microphones or a microphone array, for recording audio or sound, a loudspeaker unit 19 for outputting audio or sound, a processing unit 20 comprising, for example, one or more processors for digital signal processing, a main memory 21, a non-volatile memory 22 for storing mobile apps 23 for execution by the processing unit, and a display unit 24 with a display for displaying, inter alia, messages and/or selectable items to a user, wherein the display may be touch-sensitive and configured for receiving touch-inputs from the user. The mobile device 8 further comprises a wireless communications unit 25. Respective components are generally known in the field of smartphone technology, for example, wherein the mobile device may comprise additional components known in the art. The components of the mobile device 8 are operatively coupled in a known manner.

The non-volatile memory may store an app 23 that includes instructions, which, when executed by the processing unit 20 cause the mobile device 8 to carry out a method according to any embodiment discussed herein.

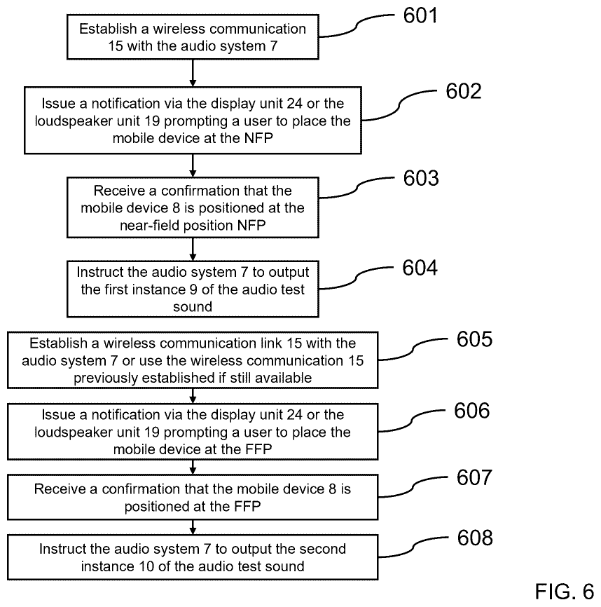

In connection with the mobile device as shown in FIG. 5, various methods according to the present disclosure may comprise, as schematically indicated in the flowcharts of FIG. 6:
establish 601 a wireless communication 15 (as shown in FIG. 1) with the audio system 7;
issue 602 a notification via the display unit 24 or the loudspeaker unit 19 prompting a user to place the mobile device at the NFP;
receive 603, at the mobile device 8, for example via a touch input on the display of the display unit 24 or via a voice input over the microphone unit 18 (more generally via a user interface), a confirmation that the mobile device 8 is positioned at the near-field position NFP; and
instruct 604, by the mobile device 8, e.g., after receiving a corresponding command via the display unit 24 or the microphone unit 18, the audio system 7 to output the first instance 9 of the audio test sound; wherein, as intermediary process steps, the mobile device 8 may issue a notification (via the display or the loudspeaker) of a proper recording of the first instance 9 of the audio test sound, or the mobile device may issue a notification of a failed recording of the first instance 9 of the audio test sound together with an instruction to repeat the recording of the first instance 9 of the audio test sound.

The above steps are related to recording the first instance 9 of the audio test sound. Corresponding steps may be carried out in connection with recording the second instance 10 of the test sound at the far-field position. For example, the mobile device 8 may:
establish 605 a wireless communication link 15 (as shown in FIG. 1) with the audio system 7 or use the wireless communication 15 previously established if still available;
issue 606 a notification via the display unit 24 or the loudspeaker unit 19 prompting a user to place the mobile device at the FFP;
receive 607, at the mobile device 8, for example via a touch input on the display of the display unit 24 or via a voice input over the microphone unit 18 (more generally via a user interface), a confirmation that the mobile device 8 is positioned at the far-field position FFP; and
instruct 608, by the mobile device 8, e.g., after receiving a corresponding command via the display unit 24 or the microphone unit, the audio system 7 to output the second instance 10 of the audio test sound; wherein, as intermediary process steps, the mobile device 8 may issue a notification (via the display or the loudspeaker) of a proper recording of the second instance 10 of the audio test sound, or the mobile device 8 may issue a notification of a failed recording of the second instance 10 of the audio test sound together with an instruction to repeat the recording of the second instance 10 of the audio test sound.

Based on the recording of the first and second instances 9, 10 of the audio test sound the mobile device 8 may transmit the one or more correction filters F determined according to 206 in FIG. 2, via the wireless communication link 15 to the audio system 7.

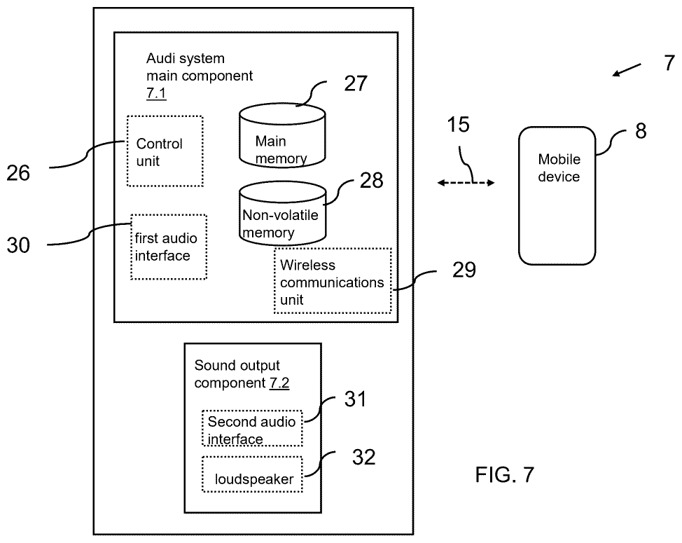

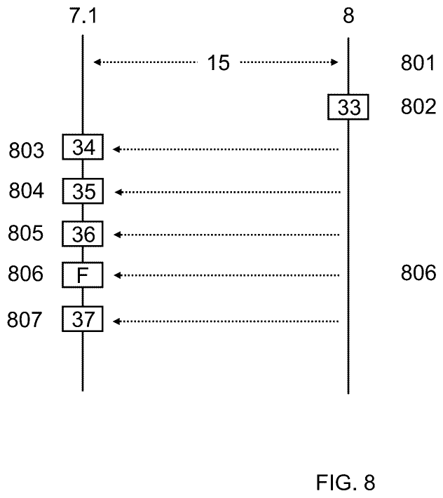

FIG. 7 schematically shows a system configuration of an audio system; and FIG. 8 shows a flowchart of audio system actions carried out in connection with various embodiments.

In connection with FIG. 7, the audio system 7 is described as comprising the audio system main component 7.1, the sound output component 7.2, and the mobile device 8. However, the present disclosure contemplates the audio system as comprising only the audio system main component 7.1 and the sound output component 7.2, and, if applicable only the sound system component 7.2, for example in case of an active loudspeaker comprising digital signal processing means and components for wireless communication with the mobile device 8. Further, the present disclosure contemplates an audio systems providing the components 7.1 and 7.2 in a single device rather than providing separate components as illustrated in FIG. 1. The mobile device 8 may be configured as described in connection with FIG. 5, and full reference is made to the above discussion.

In connection with the audio system 7, the audio system main component 7.1 may comprise a control unit 26, main memory 27, a non-volatile memory 28, and a wireless communications unit 29 configured for establishing a wireless communication link (e.g., the wireless communication link 15 shown in FIG. 1) with the mobile device 8. These or some of these components may, in alternatives and as discussed previously, be implemented with a single component, e.g., the sound output component 7.2 (which is not discussed in detail below, but the following discussion applies accordingly if the components are implemented as a single component). For example, functions and elements described in connection with the audio system main component 7.1 may be implemented on or be part of an output component (system integration).

The audio system main component 7.1 may further comprise a first audio interface unit 30 operatively coupled to or configured for being operatively coupled to a corresponding second audio interface unit 31 of the sound output component 7.2. The sound output component 7.2 may be considered as a loudspeaker or as comprising one or more loudspeakers 32. The audio interface units 30, 31 are provided for audio signal transmission from the audio system main component 7.1 to the output component 7.2 to output audio via the output component 7.2, in particular the one or more loudspeakers 32. The components of the audio system components 7.1 and 7.2 are operatively coupled as required.

In accordance with various embodiments, the non-volatile memories 22 and 28 of the audio system component 7.1 and the mobile device 8 may store instructions, which, when executed by the processing unit 20 of the mobile device 8 or the control unit 26 of the audio system component 7.1 provide a method for room correction as described in connection with any of the embodiments described herein. Particular reference is made to FIGS. 2 to 4 and 6 and the related description above.

In accordance with various embodiments, the non-volatile memories 22 and 28 may store further instructions that, when executed, provide at least one of the following actions, schematically illustrated, at least in part, in the flowchart of FIG. 8:
establish 801 a wireless communication link 15 between the mobile device 8 and the audio system component 7.1, wherein the wireless communication link 15 may subsequently be used for data exchange, as described in one or more of the following operations, between the mobile device 8 and the audio system component 7.1;
receive 802, at the mobile device, for example via a user input at the mobile device, (or alternatively and not shown from the mobile device 8), a first confirmation 32 that the mobile device 8 is positioned at the NFP;
receive 803, at the audio system main component 7.1 from the mobile device 8, a first instruction 34 to output the first instance 9 of the audio test sound, wherein the audio system main component 7.1 may, in response to receiving the first instruction 34, cause the output component 7.2 to output the first instance 9 of the audio test sound;
receive 804, from the mobile device 8 (or alternatively and not shown at the mobile device 8), a further confirmation 35 that the mobile device 8 is positioned at the FFP;
receive 805, at the audio system main component 7.1 from the mobile device 8, a second instruction 36 to output the second instance 10 of the audio test sound, wherein the audio system main component 7.1 may, in response to receiving the second instruction 36, cause the output component 7.2 to output the second instance 10 of the audio test sound; and
transmit 806, from the mobile device 8 and receive at the audio system main component 7.1, the one or more correction filters F for application, by the audio system main component 7.1, to output audio.

In various embodiments, the processing of the near-field and far-field sound recordings and/or the modelling of the correction filter(s) may be carried out by the mobile device 8, wherein in alternative embodiments, the signal processing may, at least in part, be carried out by the audio system main component 7.1 (e.g., control unit 26). In such embodiments, the near-field and far-field sound recording may be transmitted by the mobile device 8 to respective entities.

Having determined the correction filter(s) F, the audio system main component 7.1 may apply the one or more correction filters F to subsequent audio output, which may, for example in connection with various embodiments, comprise receiving 807, at the audio output main component 7.1 a third instruction 37 to apply the correction filters F to subsequent audio. The determined correction filters F may be stored in the non-volatile memory 22 and/or 28 with an identifier indicating an associated far-field position ID (or name). For example, the filters F may be stored on the mobile device 8 or in the mobile app 23 together with the ID for selection by a user if required or desired.

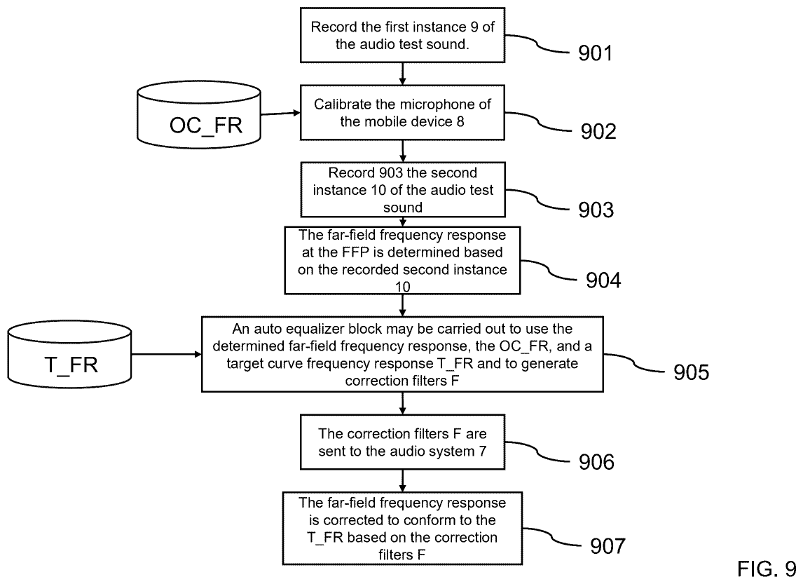

FIG. 9 shows a further flowchart of a method according to various embodiments. The method according to FIG. 9 corresponds with one or more embodiments described above and is for room correction of an initially and such unknown far-field frequency response characteristic.

The method as shown in FIG. 9 comprises recording 901, with the mobile device 8 to be operated by a user and placed at the NFP, the first instance 9 of the audio test sound. A known, e.g., previously determined, output component frequency response characteristic or curve OC_FR may be provided as additional input. The OC_FR may be determined based on a reference microphone in an anechoic chamber as described further above. The OC_FR may be stored on the mobile device 8 and/or on the audio system 7, and provided to the mobile device 8, more particularly to the app 23 if required. The OC_FR and the frequency response determined from the recording of the first instance 9 of the audio test sound is used for calibrating 902 the microphone of the mobile device 8 such that a calibrated microphone may be provided for recording the second instance 10 of the audio test sound.

After calibrating the microphone, the method may comprise recording 903, with the calibrated microphone of the mobile device 8 to be operated by a user and placed at the NFP, the second instance 10 of the audio test sound. Based on the recorded second instance 10 of the audio test sound, and at 904, the far-field frequency response at the FFP, i.e., the listening position, is determined. Having determined the far-field frequency response at the FFP with the previously calibrated microphone, an auto equalizer block, implemented for example as a software-based auto equalizer, may be carried out at 905. The auto equalizer may use the determined far-field frequency response, the OC_FR, and a target curve frequency response T_FR as additional input, received for example from a data-base stored in the non-volatile memory of the mobile device 8 or otherwise, and generate one or more or a set of correction filters F for correcting audio output to conform to the T_FR. At 906, the correction filters F may be sent, for example based on a user instruction received at the mobile device 8, to the audio system 7, e.g., to the audio component 7.1 or 7.2. Based on the correction filters F, the far-field frequency response, in particular the frequency response at the listening position 6, may, at 907, be corrected to conform to the T_FR. According to this and various embodiments, an automated equalizer function may be implemented, the automated equalizer function providing at least semi-automated room correction as discussed in various embodiments herein.

In all, the above discussion reveals that the embodiments according to the present disclosure provide improved methods and systems for room correction and solve the underlying problem.

The exemplary embodiments shown and described in connection with the figures have been provided for a better understanding of the invention. However, the scope of the claims shall not be limited by the disclosure provided in connection with these exemplary embodiments.

### LIST OF REFERENCE SIGNS

1 room
2 walls
3 floor
4 furniture
5 couch
6 preferred seating position
7 audio system
7.1 audio system main component
7.2 sound output component, e.g. loudspeaker
8 mobile device
9 first instance of audio test sound;
10 second instance of the audio test sound;
11 near-field frequency response curve
12 far-field frequency response curve
13 room-gain frequency response curve
14 target frequency response curve
15 wireless communication link
16 first instructions
17 second instructions
18 microphone unit of mobile device
19 loudspeaker unit of mobile device
20 processing unit of mobile device
21 main memory of mobile device
22 non-volatile memory of mobile device
23 mobile app stored on the mobile device
24 display unit of mobile device
25 wireless communications unit of mobile device,
26 control unit of audio component
27 main memory audio component
28 a non-volatile memory audio component
29 wireless communications unit audio component
30 first audio interface unit audio component
31 second audio interface unit audio component
32 loudspeaker
32, 33 confirmations
34, 36 instructions
F correction filter
MF microphone correction filter

1. A method of performing room correction for an audio system using a mobile device including at least one microphone having an unknown microphone frequency response characteristic, the audio system comprising at least one sound output component placed in a fixed position in a room and having an output frequency response characteristic, the room having an unknown room-gain frequency response characteristic, the method comprising:
obtaining a near-field sound recording generated by recording, with the at least one microphone positioned at a near-field position relative to the sound output component within the room, a first instance of an audio test sound outputted by the sound output component into the room;
obtaining a far-field sound recording generated by recording, with the at least one microphone positioned at a far-field position relative to the sound output component, a second instance of the audio test sound outputted by the sound output component into the room, wherein the near-field position is adjacent the sound output component and the far-field position is different from the near field position and spaced further away from the sound output component as compared to the near field position;
processing the near-field sound recording and the far-field sound recording and extracting from the near-field sound recording a near-field frequency response curve and extracting from the far-field sound recording a far-field frequency response curve;
extracting from the far-field frequency response curve a room-frequency response curve corresponding to the room-gain frequency response characteristic by eliminating, based at least on the near-field frequency response curve, the output frequency response characteristic and the at least one microphone frequency response characteristic;
modelling, based on the room-gain frequency response curve and a given target frequency response curve, one or more correction filters for application on audio signals of the sound output component, the one or more correction filters cancelling out at least the room-gain frequency characteristic and correcting the audio signals to obtain, at the far-field position, the target frequency response characteristic corresponding to the target frequency response curve.

2. The method of claim 1, further comprising recording the near-field sound recording and the far-field sound recording with the mobile device including the at least one microphone.

3. The method of claim 1, wherein, in the near-field position, a distance between the at least one microphone and the sound output component is 10 cm at most.

4. The method of claim 1, wherein the mobile device is selected from the group comprising: smartphones, tablet computers, laptops, headphones comprising one or more microphones, and remote controls comprising a microphone input.

5. The method of claim 1, further comprising:
establishing a wireless communication link between the mobile device and the audio system;
instructing, by the mobile device placed in the near-field position, via first instructions transmitted over the wireless communication link, the audio system to output the first instance of the audio test sound; and
instructing, by the mobile device placed in the far-field position, via second instructions transmitted over the wireless communication link, the audio system to output the second instance of the audio test sound.

6. The method of claim 1, further comprising:
transmitting the correction filter via a wireless communication link established between the mobile device and the audio system to the audio system; and
by the audio system, applying the correction filter to an audio output.

7. The method of claim 1, wherein the eliminating of the microphone frequency response characteristic and the output frequency response characteristic comprises:
determining a microphone frequency response curve based on a calculated difference of the near-field frequency response curve and a known frequency response curve of the output component;
modelling a microphone correction filter based on the microphone frequency response curve, the microphone correction filter cancelling out the microphone frequency response characteristic;
applying the microphone correction filter to the far-field sound recording; and
eliminating the output frequency response characteristic from the far-field frequency response curve by subtracting the known output frequency response curve.

8. The method of claim 1, wherein the eliminating of the microphone frequency characteristic and the output frequency response characteristic comprises eliminating the microphone frequency characteristic and the output frequency response characteristic based on a calculated difference between the far-filed frequency response curve and the near-field frequency response curve.

9. The method of claim 1, wherein the target frequency response curve corresponds to a frequency response curve of the output component.

10. The method of claim 1, wherein the target frequency response curve corresponds to a substantially flat frequency response curve.

11. The method of claim 1, wherein the target frequency response curve corresponds to a virtual room-gain frequency response curve providing, when applying the correction filter to audio signals, a desired room gain characteristic at the far-field position.

12. A non-transitory, computer-readable storge medium comprising instructions that, when executed by one or more processing units of a computing device, causes the one or more processing units to carry out a method comprising:
obtaining a near-field sound recording generated by recording, with a microphone positioned at a near-field position relative to an output component of an audio system placed within a room, a first instance of an audio test sound outputted by the sound output component into the room;
obtaining a far-field sound recording generated by recording, with the microphone positioned at a far-field position relative to the output component, a second instance of the audio test sound outputted by the sound output component into the room, wherein the near-field position is adjacent the sound output component and the far-field position is different from the near field position and spaced further away from the sound output component as compared to the near field position;
processing the near-field sound recording and the far-field sound recording and extracting from the near-field sound recording a near-field frequency response curve and from the far-field sound recording a far-field frequency response curve;
extracting from the far-field frequency response curve a room-frequency response curve corresponding to the room-gain frequency response characteristic by eliminating, based at least on the near-field frequency response curve, the output frequency response characteristic and the microphone frequency response characteristic;
modelling, based on the room-gain frequency response curve and a given target frequency response curve, one or more correction filters for application on audio signals of the output component, the correction filter cancelling out at least the room-gain frequency characteristic and correcting the audio signals to obtain, at the far-field position, the target frequency response characteristic corresponding to the target frequency response curve.

13. A mobile device comprising at least one microphone for recording audio sound and at least one processing unit, and a non-volatile memory, the non-volatile memory storing instructions, which, when executed by the at least one processing unit, cause the at least one processing unit to perform a method comprising:
obtaining a near-field sound recording generated by recording, with the microphone positioned at a near-field position relative to an output component of an audio system placed within a room, a first instance of an audio test sound outputted by the sound output component into the room;
obtaining a far-field sound recording generated by recording, with the at least one microphone positioned at a far-field position relative to the output component, a second instance of the audio test sound outputted by the sound output component into the room, wherein the near-field position is adjacent the sound output component and the far-field position is different from the near field position and spaced further away from the sound output component as compared to the near field position;
processing the near-field sound recording and the far-field sound recording and extracting from the near-field sound recording a near-field frequency response curve and from the far-field sound recording a far-field frequency response curve;
extracting from the far-field frequency response curve a room-frequency response curve corresponding to the room-gain frequency response characteristic by eliminating, based at least on the near-field frequency response curve, the output frequency response characteristic and the microphone frequency response characteristic;
modelling, based on the room-gain frequency response curve and a given target frequency response curve, one or more correction filters for application on audio signals of the output component, the correction filter cancelling out at least the room-gain frequency characteristic and correcting the audio signals to obtain, at the far-field position, the target frequency response characteristic corresponding to the target frequency response curve.

14. The mobile device of claim 12 further comprising a wireless communication unit operatively coupled to the at least one processing unit, and wherein the non-volatile memory includes further instructions that, when executed by the at least one processing unit, cause the mobile device to carry out at least one of the following actions:
establish a wireless communication with the audio system;
issue a notification prompting a user to place the mobile device at the near-field position;
receive a confirmation that the mobile device is positioned at the near-field position;
instruct the audio system to output the first instance of the audio test sound;
issue a notification prompting a user to place the mobile device at the far-field position;
receive a confirmation that the mobile device is positioned at the far-field position;
instruct the audio system to output the second instance of the audio test sound; and
transmit the one or more correction filters to the audio device for application to output audio.

15. An audio system comprising at least one sound output component placed in a room and at least one first control unit, a mobile device comprising a microphone and at least one second control unit, the first control unit operatively coupled to a first wireless communication unit of the audio system, and the second control unit operatively coupled to a wireless communication unit of the mobile device, wherein the first control unit comprises a first processing unit and a first non-volatile memory, and the second control unit comprises a second processing unit and second non-volatile memory, the first and second non-volatile memories storing instructions, which, when executed by the first and second processing unit, respectively, cause the audio system to carry out a method comprising:
obtaining a near-field sound recording generated by recording, with the microphone positioned at a near-field position relative to the output component within the room, a first instance of an audio test sound outputted by the sound output component into the room;
obtaining a far-field sound recording generated by recording, with the microphone positioned at a far-field position relative to the output component, a second instance of the audio test sound outputted by the sound output component into the room, wherein the near-field position is adjacent the sound output component and the far-field position is different from the near field position and spaced further away from the sound output component as compared to the near field position;
processing the near-field sound recording and the far-field sound recording and extracting from the near-field sound recording a near-field frequency response curve and from the far-field sound recording a far-field frequency response curve;
extracting from the far-field frequency response curve a room-frequency response curve corresponding to the room-gain frequency response characteristic by eliminating, based at least on the near-field frequency response curve, the output frequency response characteristic and the microphone frequency response characteristic;
modelling, based on the room-gain frequency response curve and a given target frequency response curve, one or more correction filters for application on audio signals of the output component, the correction filter cancelling out at least the room-gain frequency characteristic and correcting the audio signals to obtain, at the far-field position, the target frequency response characteristic corresponding to the target frequency response curve.

16. The audio system of claim 14, wherein the first non-volatile memory and the second non-volatile memory comprise further instructions that, when executed by at least one of the first processing unit and the second processing units, cause the audio system to carry out at least one of the following actions:
establish a wireless communication link between the mobile device and the audio system;
receive, from the mobile device or at the mobile device, a confirmation that the mobile device is positioned at the near-field position;
receive, at the audio system from the mobile device, an instruction to output the first instance of the audio test sound;
receive, from the mobile device or at the mobile device, a confirmation that the mobile device is positioned at the far-field position;
receive, at the audio system from the mobile device, an instruction to output the second instance of the audio test sound;
transmit from the mobile device and receive at the audio system the one or more correction filters for application, by the audio system, to output audio;
receive, from the mobile device at the audio system, the near-field sound recording and the far-field sound recording and modelling, by the audio system, the one or more correction filters; and
apply, by the audio system, the one or more correction filters to audio output.
